(19) United States
(12) Patent Application Publication
(10) Pub. No.: US 2004/0016171 A1
(43) Pub. Date: Jan. 29, 2004

(54) Spring loaded fishing device

(76) Inventor: Andrew Waxmanski, Chipley, FL (US)

Correspondence Address: Richard C.Litman, LITMAN LAW OFFICES, LTD., P.O. Box 15035, Arlington, VA, 22215, US

(21) Appl. No.: 10/455,530

(22) Filed: Jun. 6, 2003

Related U.S. Application Data
(60) Provisional application No. 60/398,111, filed on Jul. 25, 2002.

(51) Int. Cl. A01K 97/12

(52) U.S. Cl. 43/15

(57) ABSTRACT

A spring loaded fishing device couples a fishing line, extending from a fishing rod and reel, to a leader or bait line. The fishing device has a spring mounted in a cylinder. A shaft, coupled to the spring, extends from the cylinder. The spring biases the shaft to a withdrawn position, resisting extension of the shaft. As a fish nibbles on the baited hook the shaft is extended against the spring, increasing a reactive force tending to return the shaft to its original position. Thus, as a fish tugs on a lure or bait, the spring loaded fishing device pulls the lure or bait back away from the fish, causing the fish to make a more aggressive strike at the lure or bait. Several embodiments of springs for accomplishing the desired action are described.

### CROSS-REFERENCE TO RELATED APPLICATION

This application claims the benefit of U.S. Provisional Patent Application Serial No. 60/398,111, filed Jul. 25, 2002.

### BACKGROUND OF THE INVENTION

1. Field of the Invention

The present. invention relates to a device used to catch fish. More specifically, the invention is a spring-loaded fishing device that couples a leader or bait line to a fishing line extending from a fishing rod, and allows the bait line to displace independently of the fishing when an external force is applied. The spring-loaded fishing device entices a fish to aggressively strike the bait and take the hook by pulling away from the fish as the fish nibbles on the bait.

2. Description of Related Art

The related art of interest describes various artificial lures that respond to a striking fish by either having hooks that are either exposed initially and retract towards the lure when a fish strikes, or are retracted in the lure initially and extend to become exposed when a fish strikes. However, none disclose a resilient device that is attached inline in a fishing line between the reel and the hook and bait or lure.

The related art will be discussed in the order of perceived relevance to the present invention.

U.S. Pat. No. 4,242,827 issued to Smith discloses a fishing lure that has a flexible outer plug with an air compartment and a stink bait compartment. The fishing line is attached to a flat metal spring at one end and the hook at the other end. The hook is housed within the flexible tube and is exposed when a fish strikes the lure which then deflects the tube to expose the hook.

U.S. Pat. No. 5,640,796 issued to Barrows discloses a hook system contained within the body of a lure. The hook retracts when a fish bites the lure at one end and the fisherman pulls on the fishing line at the other end. The hook extends out of the lure via a cam-surfaced plug.

U.S. Pat. No. 5,535,540 issued to Crumrine discloses a jigging system apparatus. The jigging system apparatus allows the weight to be altered without removing the entire lure. The jigging apparatus has a sinker body that houses a hook locking means that is attached to a fishhook.

U.S. Pat. No. 3,981,094 issued to Guerin discloses an artificial lure that has a spring loaded hook. The hook pivotally swings 180° into an engaged position when a predetermined force is applied.

U.S. Pat. No. 4,024,668 issued to McDiarmid et al., discloses an artificial lure with a hook biasing means. The hooks are spring-biased to a position retracted within the lure body. When a predetermined force is applied the hooks extend to an exposed position.

U.S. Pat. No. 3,657,836 issued to Harris discloses a fishing plug with paired snag-less hooks. The hooks are exposed is with the barbed portion up against the lure so as to prevent snagging on weeds or the like. The hooks engage when a fish bites the lure, which causes the hooks to spring open.

None of the above inventions and patents, taken either singly or in combination, is seen to describe the instant invention as claimed.

### SUMMARY OF THE INVENTION

The present invention is a spring loaded fishing device that. joins a fishing line, extending from a fishing rod and reel, to a leader or bait line leading to a baited hook or artificial lure. The spring loaded fishing device is designed to allow the bait line to be tugged by a fish and momentarily displaced independently from the fishing line. When the bait line is displaced the spring loaded fishing device creates a reactive force tending to pull the bait or lure back away from the fish, adding a life like movement to the baited hook or lure.

Fish often nibble at a bait or lure, taking the bait or lure in their mouth and tugging, and then letting go. As the fish tugs at the bait or lure, the spring loaded fishing device applies an opposite force to pull the bait away from the fish, teasing the fish. This teasing action causes the fish to aggressively strike at the bait or lure, thus ensnaring the fish to the hook.

Alternatively when fishing by casting and retrieving an artificial lure, a certain amount of drag is created on the artificial lure that in effect applies a tension force on the spring. The spring then applies a reactive force (RF) to overcome the tension force and pulls or jerks the lure toward the spring. This springing action increases the tendency for the artificial to attract fish.

Accordingly, it is a principal object of the present invention to apply a reactive force to a baited hook or artificial lure when an outside force is applied to the hook.

It is another object of the invention to provide life like movement to a baited hook or artificial lure by causing the baited hook or artificial lure to pull away from a fish as the fish plays with or nibbles on the hook.

It is a further object of the invention to have a quick reactive force so as to hook the fish on the line.

Still another object of the invention is to provide life like movement to the baited hook as it is being pulled through the water.

Another object of the invention is to allow an angler to place the spring loaded fishing device anywhere on the fishing line depending on the type of fishing.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an elevation view of a hook and bait line according to the present invention.

FIG. 2 is a cross-sectional side view of the invention at rest.

FIG. 3 is a view similar to FIG. 2, but showing the invention when a force is applied to the hook.

FIG. 4 is a cross-sectional side view of another embodiment of the invention.

FIG. 5 is a cross-sectional side view of yet another embodiment of the invention.

Similar reference characters denote corresponding features consistently throughout the attached drawings.

### DETAILED DESCRIPTION OF THE PREFERRED EMBODIMENTS

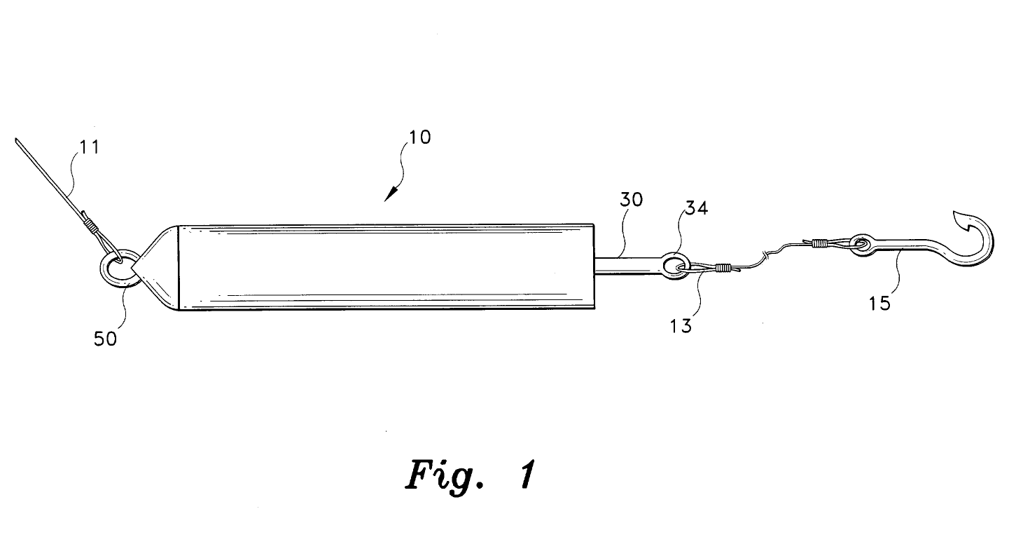

The invention is a spring loaded fishing device designated generally as 10 in the drawings. Turning to FIG. 1, the spring loaded fishing device 10 is shown attached to a fishing line 11 at cap eyelet 50. A shank 30 is shown extending from the spring loaded fishing device 10 with a shank eyelet 34 coupled to a leader or bait line 13 with a hook 15. It is noted that fishing line 11 and bait line 13 could be fastened to either cap eyelet 50 or shaft eyelet 34. For discussion purposes, the spring loaded fishing device 10 will be described with fishing line 11 tied to cap eyelet 50 and bait line 13 tied to shaft eyelet 34. Also, the length of bait line 13 is dependent upon the type of fishing being performed and the desired characteristics. Fishing line 11 is typically a heavier fishing line than bait line 13. In this way if the line is snagged or breaks the break will occur along bait line 13 so as to retain device 10.

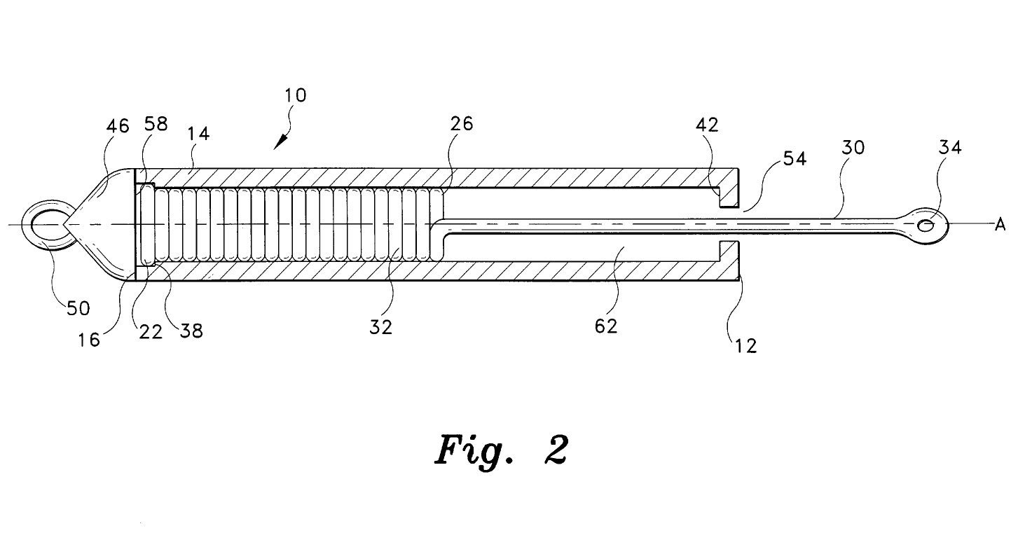

FIG. 2 shows the interior of device 10. A cylinder 14 with a forward end 16 and a rearward end 12 defines a hollow chamber 62. Cylinder cap 46 is releasably attached to forward end 16 of cylinder 14 to allow access to chamber 62. A rear cylinder end cap 42 is located at the rearward end 12 of cylinder 14. End cap 42 may also be releasably attached to rearward end 12, or formed integrally with cylinder 14. End cap 42 also has a chamber outlet 54. Near the forward end 16 of cylinder 14, where cylinder cap 46 secures to cylinder 14, is chamber ridge 38. Chamber ridge 38 and cap inner face 58 both define an area between which a forward portion of a spring is housed.

Extension spring 32 is housed within chamber 62. Extension spring 32 has a free length with opposing forward end coil 22 and rearward end coil 26. Forward end coil 22 has a slightly greater outer diameter than the rest of the extension spring 32 so as to catch on ridge 38 when placed in chamber 62. Rearward end coil 26 has an extension or elongate shank 30. Shank 30 extends away from the extension spring 32 and is parallel to the center longitudinal axis A of extension spring 32. The distal end of shank 30 has shank eyelet 34 for fastening to bait line 13.

To assemble the invention, the rearward end coil 26 and shank 30 are first inserted into chamber 62. As extension spring 32 is dropped into chamber 62 forward end coil 22 is retained or catches on ridge 38. Shank 30 also passes through chamber outlet 54 so that a portion of shank 30 and shank eyelet 34 protrude out of chamber 62. Cylinder cap 46 is then secured to cylinder 14 at forward end 13 so as to retain forward end coil 22 of extension spring 32. Fishing line 11 is then tied to cap eyelet 50 and bait line 13 tied to shank eyelet 34.

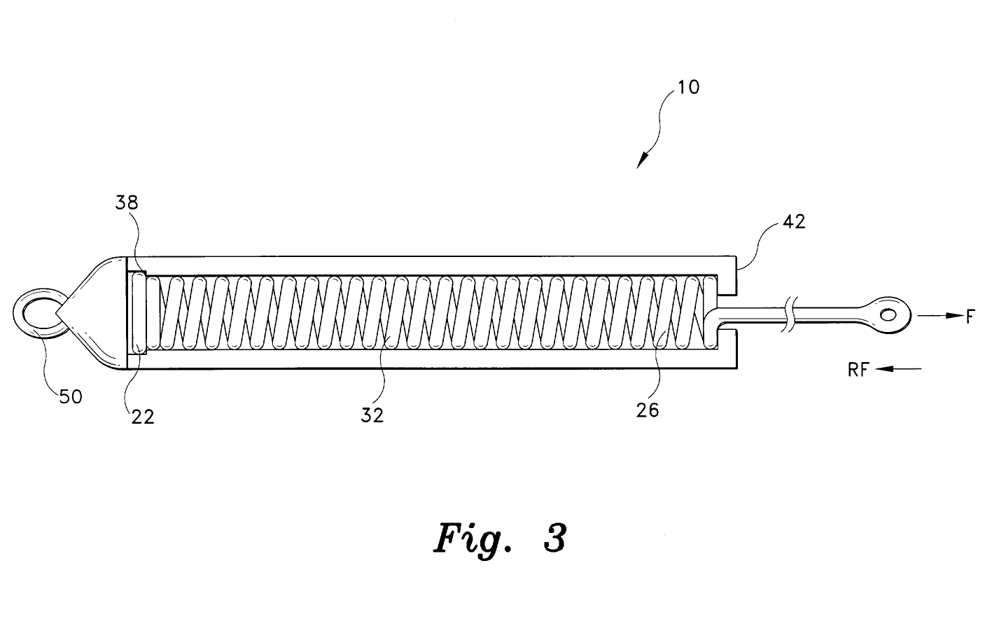

The extension spring 32 can have a variety of spring designs depending upon the type of fishing being performed. For example, and as shown in FIG. 3, extension spring 32 can be designed to respond to the slightest amount of external force F. When tension, force F, is applied to the extension spring, such as by a fish nibbling or playing with a connected bait, the extension spring 32 is displaced from a free length position to a deflected position. In this deflected position extension spring 32 applies an opposite or reactive force RF until returned to the free length position. In this manner extension spring 32 acts as a teaser by pulling the bait away from the mouth of the fish in response to the fish pulling on the bait.

With this teasing action the fish is enticed to strike aggressively at the lure or baited hook thus ensnaring the fish. The spring loaded fishing device 10 is designed with a cylinder 14 length so that the extension spring 32 does not pass its elastic limit. As the fish fights to get loose or pulls away from bait line 13, a greater amount of force F is applied and the extension spring 32 deflects further past the free length. The extension spring 32 reaches a maximum allowable stress when the rearward end coil 26 butts up against end cap 42. At this point force F is transferred to cylinder 14, the fishing line 11 and ultimately the angler. End cap 42 thus prevents the extension spring 32 from reaching a permanent set and losing its elasticity.

End cap 42 does not necessarily have to be placed at the rearward end 12 of cylinder 14. The placement of end cap 42 or a stopper can be determined by the following equation:

Force(F)=k(D_{(standing)}−D_{(Deflected)})

where

F=Force

k=spring constant

D_{(Standing)}=free length of spring

D_{(Deflected)}=length of spring deflected

In this manner end cap 42 can be placed anywhere within chamber 62 depending the spring characteristics, the force applied, and the distance displaced.

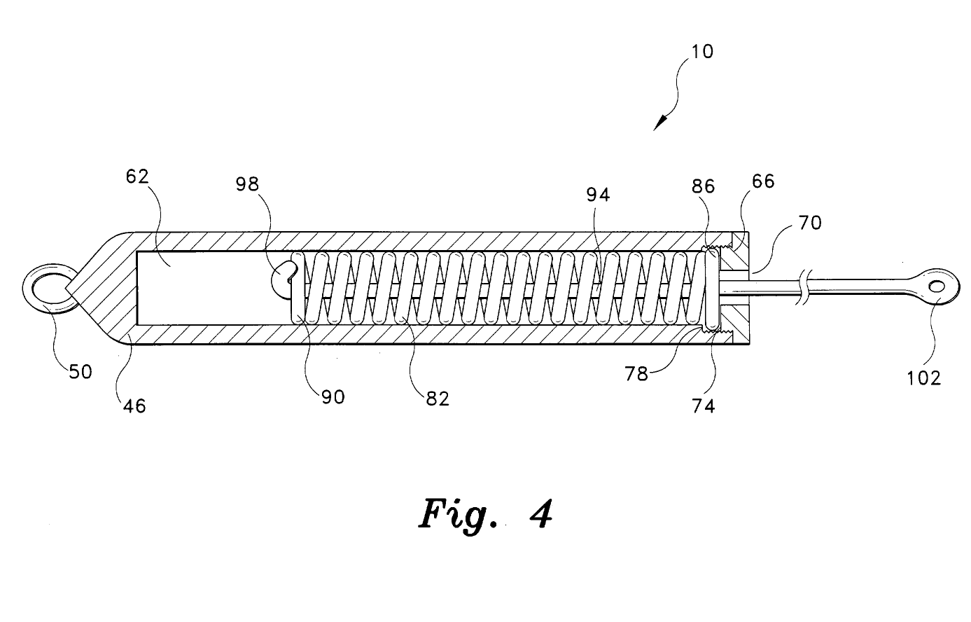

FIG. 4 shows another embodiment. A compression spring 82 is used instead of extension spring 32. Much like extension spring 32, compression spring 82 applies a reactive force RF when deflected from the free length of compression spring 82. The only difference, essentially, is that compression spring 82 resists being deflected and thus buckling within chamber 62.

Compression spring 82 has a forward end loop 90 and a rearward end loop 86. In this embodiment rearward end loop 86 has a slightly larger diameter than the rest of compression spring 82 so as to be retained on ledge 78. A center shaft 94 extends the longitudinal length of compression spring 82 and is disposed within the circular coils that make up compression spring 82. Center shaft 94 has two opposing ends. One of these ends is shaft end loop 98, which is rigidly affixed to forward end loop 90 by soldering or any other known method. Center shaft 94 extends through compression spring 82 and past the rearward end loop 86 and terminates at shaft eyelet 102.

Access to inner chamber 62 is through the rear end of cylinder 14 via detachable end plug 66. To assemble this embodiment, the forward end loop 90 is inserted first within chamber 62. Rearward end loop 86 of compression spring 82 butts up against rear ridge 78 of cylinder 14. End plug 66 has rear outlet 70 so as to slip shaft eyelet 102 through and also allow end plug 66 to be attached to the rearward end 15 of cylinder 14. Inner face 74 of end plug 66 and rear ridge 78 provide a space to retain the rearward end loop 86 of compression spring 82.

When a fish applies tension force F to bait line 13 the force is transferred along center shaft 94, to shaft front end 98, and to forward end loop 90. Forward end loop 90 is then compressed toward the retained rearward end loop 86 displacing compression spring 82 from a free length position. Compression spring 82 then applies a reactive force RF in the opposing direction of compressive force F. End plug 66 also acts as the stop and compression spring 82 has a maximum allowable compressive force F. In this embodiment there is no danger of compression spring 82 losing its elasticity as the permanent set of compression spring 82 is never reached.

There are several alternatives to compression spring 82 available. A few examples are a simple limited-travel extension spring, cone spring, and a variable pitch spring.

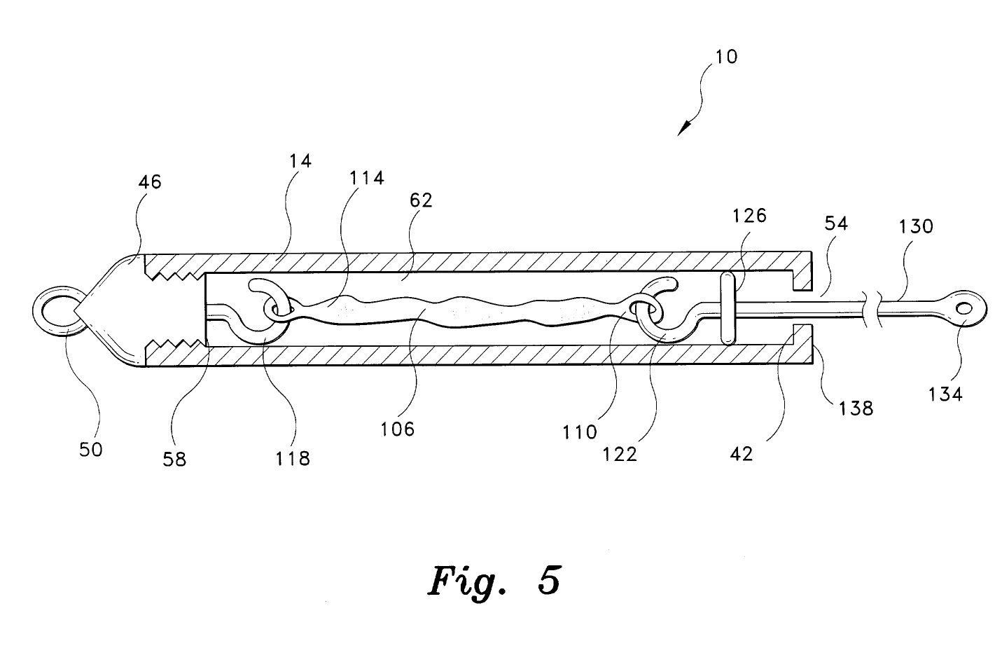

FIG. 5 discloses yet another embodiment of the spring loaded fishing device 10. In this embodiment a compliant member 106 is used to apply reactive force (RF) when displaced from a stable position. Cylinder cap 46 is removably attached with the forward end of cylinder 14. Cylinder cap 46 has a securing fastener 118 on inner face 58 to retain a front loop 114 of compliant member 106. A rear loop 110 of compliant member 106 attaches to shank fastener 122 of shank 130.

Shank 130 also has stopper 126 that is housed within chamber 62. Stopper 126 limits the amount of load on compliant member 106. When the predetermined load is reached stopper 126 butts up against the rear cylinder end cap 42 so as to transfer the majority of the load to cylinder 14 and fishing line 11. Shank 130 is of sufficient length so that if shank 130 is in a fully retracted position shank eyelet 134 remains exposed through outlet 128. Alternatively, a stopping device may be provided on the external portion of shank 130 to prevent eyelet 134 from retracting within outlet 54.

One skilled in the art will appreciate that compliant member 106 has the added benefit of being manufactured from any elastic or compliant material. An added benefit occurs when choosing a material that does not rust when exposed to water such as rubber.

Also cylinder rear end 138 can have the general cone shape of cylinder cap 46. In this manner either end could be tied to fishing line 11.

In another embodiment, the spring can be placed in cylinder 14 in a retained deflected position, so that when a fish applies the slightest force to bait line 13 it triggers or unlatches the deflected spring. The sudden release allows the spring to release all of the stored energy to return back to the free length position. This sudden releasing of the spring quickly pulls or lunges the hook or lure toward the spring loaded fishing device 10 ensnaring the fish.

The present invention may operate with any compliant mechanism designed to allow a predefined displacement and returning to a stable rest position, so long as the compliant mechanism couples the fishing line and the bait line.

It is to be understood that the present invention is not limited to the embodiments described above, but encompasses any and all embodiments within the scope of the following claims.

I claim:

1. A spring loaded fishing device that responds to an external force, the spring loaded fishing device comprising:
a cylinder having a forward end, a hollow chamber and a rearward end;
a front cap disposed on the forward end of said cylinder;
an eyelet disposed on said front cap;
a rear closure disposed on said rearward end, the rear closure having an aperture formed therein;
an elongated shank having a first end and a second end, the first end of the shank being disposed in said hollow chamber, the second end of the shank extending through the aperture in said rear closure;
bias means for biasing said elongated shank to a withdrawn position in said hollow chamber, the bias means being disposed inside said hollow chamber, the bias means engaging the first end of said elongated shank.

2. The fishing device according to claim 1, wherein said bias means comprises a tension spring.

3. The fishing device according to claim 1, wherein said bias means comprises a compression spring.

4. The fishing device according to claim 1, wherein said bias means comprises a compliant, elastic member.

5. The fishing device according to claim 1, wherein said front cap is integrally formed on said cylinder.

6. The fishing device according to claim 1, wherein:
said cylinder further comprises a forward threaded region formed on an inner surface of said cylinder at said forward end; and
said front cap further comprises a threaded portion for engagement with said forward threaded region.

7. The fishing device according to claim 1, wherein said rear closure is integrally formed on said cylinder.

8. The fishing device according to claim 1, wherein:
said cylinder further comprises a rearward threaded region formed on an inner surface of said cylinder at said rearward end; and
said rear closure further comprises a threaded portion for engagement with said forward threaded region.
